(19) United States
(12) Patent Application Publication
(10) Pub. No.: US 2005/0006946 A1
(43) Pub. Date: Jan. 13, 2005

(54) Method for brake control of a motor vehicle trailer

(76) Inventors: Ansgar Traechtler, Ditzingen-Hirschlanden (DE); Dietmar Arndt, Hatvan (HU)

Correspondence Address: RONALD E. GREIGG;GREIGG & GREIGG P.L.L.C., Suite One, 1423 Powhatan Street, Alexandria, VA, 22314, US

(21) Appl. No.: 10/870,963

(22) Filed: Jun. 18, 2004

(30) Foreign Application Priority Data
Jun. 18, 2003 (DE) 1 03 27 564.9

(51) Int. Cl. B60T 13/00

(52) U.S. Cl. 303/7

(57) ABSTRACT

A method for brake control of a motor vehicle trailer having a brake system that can exert different braking forces on the left and right sides by measuring a lateral force and preferably also a longitudinal and/or vertical force in a trailer coupling, determining an overall braking force for the trailer, and determining a braking difference between the left and right sides of the trailer. The invention makes it possible to stabilize the tractor vehicle with an attached trailer and makes it possible to effectively counteract a weaving or “jack-knifing” of the tractor vehicle during cornering.

### BACKGROUND OF THE INVENTION

1. Field of the Invention

The invention relates to a method for brake control of a motor vehicle trailer, wherein the trailer has a brake system that can exert different braking forces on the right and left sides. The invention also relates to a trailer and to a tractor vehicle equipped to execute the method. The invention is suited to passenger vehicle trailers and tractor-trailers alike as well as to motorcycle trailers. The trailers can have one or more axles and particularly in the latter case, can have one steering axle. The invention can also be used in a tractor vehicle with several trailers, i.e. on a trailer that is attached to another trailer. In this instance, though, it is not an absolute requirement for all of the trailers to have a brake control system according to the invention.

2. Description of the Prior Art

In the context of the invention, a brake control of a trailer is understood to mean a regulation or control of a braking force or braking moment in wheel brakes of the trailer, the braking force and braking moment normally being proportional to each other. One requirement of the invention is that the trailer permit different levels of braking force to be produced on the left and right sides, i.e. it must be possible to set a different level of braking force in the wheel brakes of a left and right wheel of the trailer. Fundamentally, it can suffice if the braking force of a wheel brake of one wheel of the trailer can be increased and decreased in relation to the other wheel brakes of the trailer.

EP 686 839 A2 has disclosed a trailer coupling for motor vehicle trailers with a longitudinal force measuring device and an additional vertical force measuring device. The known force measuring device is embodied as an elastically deformable intermediate part, which is screw-connected to parts of the trailer coupling. Forces transmitted from a tractor vehicle to a trailer are transmitted via the intermediate part and cause it to elastically deform. The deformations of the intermediate part by longitudinal and vertical forces are measured by means of strain gauges and the longitudinal and vertical forces are calculated based on the deformations. In this connection, a longitudinal force is a tensile or compressive force in a travel direction or counter to it, transmitted by a tractor vehicle to a trailer via the trailer coupling; the vertical force is a force in the vertical direction transmitted by the trailer to the tractor vehicle via the trailer coupling. The vertical force is of particular significance during braking of a single-axle trailer; during braking, this force exerts a downward pressure on the trailer coupling. The longitudinal force transmitted via the trailer coupling can be processed as an additional control variable in the control of an antilock brake system of the tractor vehicle and/or of the trailer; the vertical force (also referred to as supporting force) is particularly used in testing for overloads.

### OBJECT AND SUMMARY OF THE INVENTION

The method according to the invention, has the advantage over the prior art that a lateral force in the region of a trailer coupling is measured and the trailer is braked on the left and/or right side as a function of the lateral force. The measurement of the lateral force does not have to take place directly in the trailer coupling; it can, for example, also be measured in a trailer drawbar or in the region in which the coupling is attached to the tractor vehicle. A value is to be measured, in particular a force, which is a function of the lateral force that is transmitted by the tractor vehicle to the trailer (or vice versa) via the trailer coupling. It is not absolutely necessary to be able to determine the intensity of the lateral force itself that is transmitted by the trailer coupling. This should be expressed with the formulation that the lateral force is measured in the region of a trailer coupling. If a lateral force occurs in the trailer coupling, then wheel brakes of the trailer are actuated with different intensity on the left and right sides or are only actuated on one side of the trailer so as to counteract the lateral force on the trailer coupling. The field of control engineering includes known methods for controlling and in particular, regulating the actuation of the wheel brakes of the trailer, which partially or completely compensate for, or possibly even overcompensate for, the lateral force on the trailer coupling. A control or regulation must be selected so as to stabilize both the tractor vehicle and trailer.

The method according to the invention can also be used for a trailer that is attached to another trailer instead of being attached to a tractor vehicle, i.e. for a tractor-trailer combination with one tractor vehicle and several trailers.

The invention has the advantage of stabilizing the motion of the tractor vehicle and/or trailer during cornering as well as during dynamic maneuvers such as lane changes and during braking—both in straightaways and in particular also during cornering. It is possible to prevent or at least reduce the known “jack-knifing” action when the trailer swings out from behind the tractor vehicle when it is being braked while cornering. It is possible to achieve a driving behavior of the tractor vehicle with the trailer that at least approximately corresponds to the driving behavior of the tractor vehicle without the trailer. The invention also counteracts a weaving of the trailer in straightaways. The tractor vehicle with the trailer is easier for the driver to control.

Preferably, in addition to the lateral force, the longitudinal force is also measured in the region of the trailer coupling. This makes it possible to reproduce the function of a mechanical inertia braking system in power-actuated trailer brake systems, for example electromechanically, pneumatically, or hydraulically actuated trailer brake systems. In addition, the longitudinal force can be processed as a control variable in an antilock brake system and/or in controlling the braking on the left and right side of the trailer in order to stabilize the tractor vehicle and trailer.

The invention also provides for the measurement of the vertical force in the region of the trailer coupling, which force can be processed as an additional control variable or used in testing for overloading.

For controlling the braking of the trailer on the left and right sides in order to stabilize the tractor vehicle and trailer, it is advantageous if the braking force is measured in the braked wheels of the trailer. There are known devices for measuring braking force in wheel brakes.

The invention also provides for equipping a trailer and a tractor vehicle, respectively, with a force measuring device in order to permit execution of the method according to the invention. Preferably, the trailer is equipped with the force measuring device so that the brake system for braking the trailer differently on the left and right sides is provided entirely on the trailer and is independent of the tractor vehicle.

### BRIEF DESCRIPTION OF THE DRAWINGS

The invention will be better understood and further objects and advantages thereof will become more apparent from the ensuing detailed description of preferred embodiments, taken in conjunction with the drawings, in which:

FIG. 1 is a perspective view of a trailer coupling according to the invention; and

FIG. 2 shows a block circuit diagram of a method according to the invention for brake control of a motor vehicle trailer.

### DESCRIPTION OF THE PREFERRED EMBODIMENTS

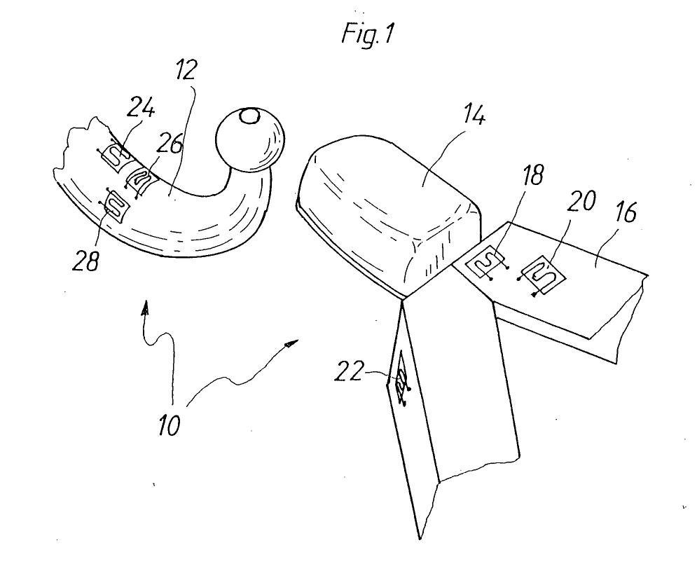

FIG. 1 shows a trailer coupling 10 with a first coupling part 12 attached to a tractor vehicle that is not otherwise shown and with a second coupling part 14 attached to a trailer that is not otherwise shown. In the exemplary embodiment shown, the first coupling part 12 is a trailer hitch of the kind commonly used in passenger vehicles and the second coupling part 14 is a trailer hitch coupler of the kind also commonly used in passenger vehicles. However, the invention can also be used in couplings for trucks. The second coupling part 14 attached to the trailer is fastened to a drawbar 16 that is provided with strain gauges 18, 20, 22. The strain gauges 18, 20, 22 constitute a force measuring device and are aligned so as to permit the measurement of lateral, longitudinal, and vertical forces transmitted by the trailer coupling 10.

The first coupling part 12 is also provided with strain gauges 24, 26, 28 that permit the measurement of lateral, longitudinal, and vertical forces transmitted by the trailer coupling 10. The strain gauges 18, 20, 22, 24, 26, 28 constitute two force measuring devices on the first coupling part 12 and the second coupling part 14, respectively. It is sufficient for only one of the two force measuring devices to be provided on either the first or second coupling part 12, 14 and for this part to be provided with only one of the two measuring devices. The drawing is merely intended to show both possibilities. Preferably, the force measuring device 18, 20, 22 is provided on the second coupling part 14 associated with the trailer so that all of the components essential to the invention are provided exclusively on the trailer. The strain gauges serving as force measuring devices are merely examples; it is possible to use any kind of force measuring devices or units that can measure the lateral, longitudinal, and/or vertical forces on the trailer coupling 10. For a simple embodiment of the invention, it is also sufficient to measure only the lateral force.

The trailer, not shown, is equipped with a power brake system, for example an electromechanical, pneumatic, or hydraulic brake system; at the very least, the braking force of one trailer wheel on each side of the trailer can be set to a different level from a braking force of the other trailer wheels.

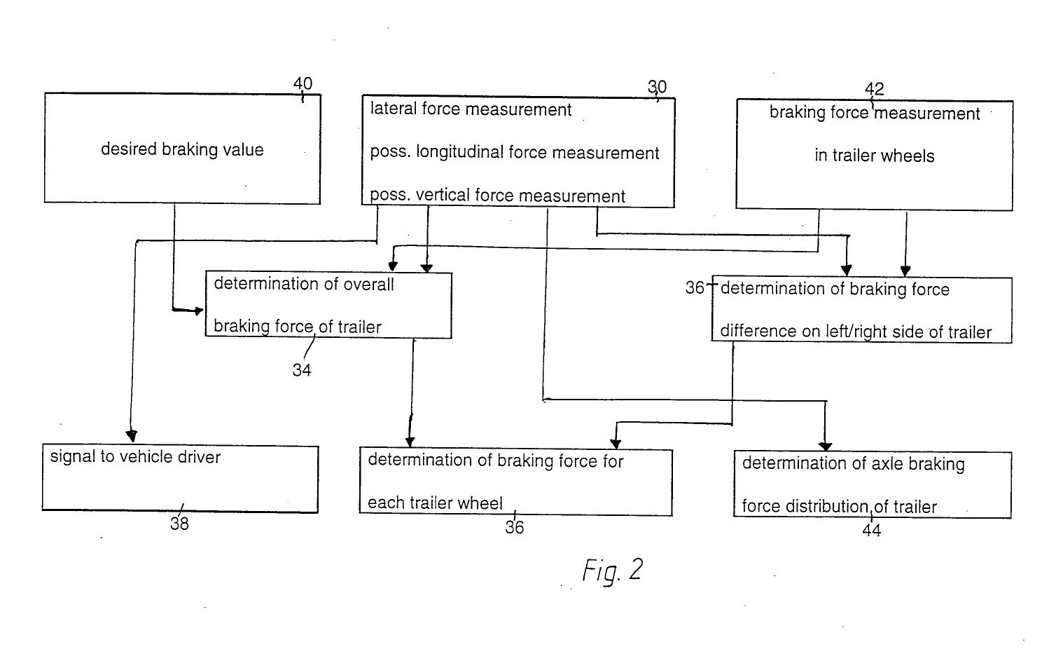

The method according to the invention will be explained in conjunction with a block circuit diagram shown in FIG. 2, in which reference numerals indicate the respective method steps in the block circuit diagram: during a driving operation of a tractor vehicle that has a trailer attached to it by means of the trailer coupling 10 shown in FIG. 1, a measurement is taken of a lateral force 30 transmitted via the trailer coupling 10. If a lateral force 30 is occurring, then a braking force difference 36 for a left and right side of the trailer is determined based on this lateral force, and the left and right trailer wheels are braked with different intensity levels in order to reduce the lateral force 30 on the trailer coupling 10. When the lateral force 30 is not very powerful, then no differential braking need be executed so as to stabilize the trailer and the tractor vehicle. Control algorithms for determining the braking force difference are known from control engineering; a control algorithm is selected so as to produce the desired stabilization of the tractor vehicle and trailer. The braking force difference on the left and right sides of the trailer can also be determined based on a characteristic field. The invention counteracts weaving and “jack-knifing” of the tractor vehicle during cornering and in particular when braking while cornering; the tractor vehicle behaves in approximately the same manner with the trailer as without it.

Preferably, in addition to the lateral force 30, the longitudinal force 30 transmitted by the trailer coupling 10 is also measured; this value is used as an additional control variable in the determination of the braking force difference 36 for the left and right sides of the trailer and is also used to determine a total braking force 34 of the trailer. By measuring the longitudinal force on the trailer coupling 10, it is possible to achieve an inertia braking function of the kind that is known from mechanical inertia braking systems.

The measurement of the vertical force 30 on the trailer coupling 10 is particularly used for monitoring overloading of the trailer coupling 10 and it can also be used as an additional control variable in the determination of the overall braking force 34 and of the braking force difference 36 between the left and right sides. In addition, with the longitudinal and/or vertical force measurement 30, it is possible to calculate an at least approximate mass of the trailer. It is therefore possible to transmit a signal 38 to a driver so as to indicate the fact that a trailer is attached and/or to also indicate at least the approximate mass of the attached trailer.

A desired braking value 40 can also be processed as an additional input value for the determination of the overall braking force 34. The desired braking value 40 is derived, for example, from a position of a brake pedal of the tractor vehicle, a hydraulic or pneumatic brake pressure of the tractor vehicle, or the like. In order to determine the overall braking force 34 of the trailer, it is sufficient to process either the desired braking value 40 or the measurement of the longitudinal force 30 on the trailer coupling 10; preferably, however, both variables are processed. The control of the braking force of the individual wheels of the trailer 36 can be improved if a measurement is taken of the actual braking force in the wheel brakes of the trailer wheels 42. Braking force measuring devices and apparatuses intended for and disposed in wheel brakes and destined for braking force measurement 42 are intrinsically known.

If the trailer has several axles, then the method according to the invention can also be used to determine an axle braking force distribution 44 for the trailer.

The invention is particularly suited to trailers that are equipped for an antilock brake control since their brake systems are equipped for an individual wheel braking and thus permit braking of different intensities on the two sides of the trailer. The only additional requirements are the force measuring device 18, 20, 22; 24, 26, 28 and a modified electronic control unit, which, in addition to the antilock brake control, also carries out the braking force control of the trailer as a function of the forces transmitted by the trailer coupling 10.

The foregoing relates to preferred exemplary embodiments of the invention, it being understood that other variants and embodiments thereof are possible within the spirit and scope of the invention, the latter being defined by the appended claims.

1. A method for brake control of a motor vehicle trailer, wherein the trailer has a brake system that can exert different braking forces on the left and right sides, the method comprising measuring a lateral force in the region of a trailer coupling (10, 12, 14), and braking the trailer on the left and/or right side as a function of measured the lateral force.

2. The method for brake control according to claim 1, further comprising measuring a longitudinal force in the region of a trailer coupling, and braking the trailer as a function of the measured longitudinal force.

3. The method according to claim 1, further comprising measuring a vertical force in the region of the trailer coupling (10, 12, 14).

4. The method according to claim 1, further comprising measuring a braking force of the trailer on the left and right sides.

5. The method according to claim 1, further comprising producing a signal (38) indicating that a trailer is attached and transmitting this signal to a tractor vehicle.

6. The method according to claim 5, further comprising producing a signal (38) related to a mass of the attached trailer, and transmitting this signal to the tractor vehicle.

7. A motor vehicle trailer with a brake system that can exert different braking forces on the left and right sides, the brake system comprising, a trailer coupling (10), a lateral force measuring device (18) on the trailer in the region of a coupling part (14) of the trailer coupling (10), which coupling part is attached to the trailer.

8. The motor vehicle trailer according to claim 7, wherein the trailer further comprises a longitudinal force measuring device (20) in the region of the coupling part (14) of the trailer coupling (10), which coupling part is attached to the trailer.

9. The motor vehicle trailer according to claim 7, wherein the trailer further comprises a vertical force measuring device (22) in the region of the coupling part (14) of the trailer coupling (10), which coupling part is attached to the trailer.

10. A tractor vehicle for a motor vehicle trailer, the tractor vehicle comprising a coupling part of a trailer coupling, and a lateral force measuring device (24) in the region of the coupling part (12).

11. The tractor vehicle for a motor vehicle trailer according to claim 10, wherein the tractor vehicle further comprises a longitudinal force measuring device (26) in the region of the coupling part (12).

12. The tractor vehicle for a motor vehicle trailer according to claim 10, wherein the tractor vehicle further comprises a vertical force measuring device (28) in the region of the coupling part (12).
